(19) United States
(12) Patent Application Publication
(10) Pub. No.: US 2022/0297421 A1
(43) Pub. Date: Sep. 22, 2022

(54) THERMOSTATIC COLOR INK CUP PAD PRINTER

(71) Applicant: FINECAUSE ENTERPRISE COMPANY LIMITED, New Taipei City (TW)

(72) Inventor: Ko-Cheng SU, New Taipei City (TW)

(73) Assignee: FINECAUSE ENTERPRISE COMPANY LIMITED, New Taipei City (TW)

(21) Appl. No.: 17/571,919

(22) Filed: Jan. 10, 2022

(30) Foreign Application Priority Data
Mar. 19, 2021 (TW) 110109931

(51) Int. Cl. B41F 31/00; B41F 17/00

(52) U.S. Cl. CPC B41F 31/002; B41F 17/001

(57) ABSTRACT

A thermostatic color ink cup pad printer includes an ink cup mechanism, a printing mechanism and a printing plate mechanism. The ink cup mechanism includes an ink cup assembly and a first driving source; the printing mechanism includes a printing pad and a second driving source; and the printing plate mechanism includes a printing plate and a base. The base is internally provided with a heating section capable of generating heat for heating the printing plate, such that the printing plate in contact with the ink cup assembly is maintained at a set temperature, and ink in the ink cup assembly in contact with the printing plate can also be kept at the set temperature in the process of pad printing.

### FIELD OF THE INVENTION

The present invention relates to a pad printer capable of maintaining an ink cup at a set temperature in the process of pad printing, and more particularly, to a pad printer, a printing plate of which is maintained at a set temperature for contacting with an ink cup, so that ink in the ink cup is also constantly heated to and maintained at the set temperature.

### BACKGROUND OF THE INVENTION

A pad printer is a commonly seen printing device and is widely applied for printing on various items, such as metal, ceramic, plastic and glass products, electronic elements, and integrated circuit (IC) packages. The pad printer includes at least one set of movable ink cup and printing plate. When one or more recessed patterns formed on the printing plate are filled with an amount of ink stored in the ink cup, differently shaped printing pads are moved to uptake the ink in the patterns on the printing plate and transfer the ink patterns onto flat, curved or spherical surfaces of items to be printed.

In printing applications, the pad printer generally uses volatile ink. Further, the ink needs to become dried fast in the process of pad printing in order to complete ink transfer successfully. In the case there are lines of different thicknesses to be printed on the items, it is necessary to adjust the volatile speed of the ink several times in the pad printing process.

In normal conditions, the ink cup and the printing plate of the pad printer are operated at room temperature. However, ambient temperature and humidity change from season to season, and such temperature and humidity changes would produce different printing effects. Therefore, it is desirable to heat the ink on the pad printer and maintain it at a constant temperature to increase the ink volatile speed; so that the ink is not subjected to any influence from the ambient temperature and the pad printing can be easily completed with upgraded stability of printing quality.

### SUMMARY OF THE INVENTION

A primary object of the present invention is to keep the ink of a pad printer at a constant temperature in the process of pad printing, so as to overcome the problem that the ink can not easily dry when being used at a lower temperature and to increase the stability of pad printing quality.

To achieve the above and other objects, the present invention provides a thermostatic color ink cup pad printer, which includes an ink cup mechanism, a printing mechanism and a printing plate mechanism.

The ink cup mechanism includes an ink cup assembly and a first driving source, and the first driving source is capable of selectively driving the ink cup assembly to perform a first movement to move horizontally or to perform a second movement to move vertically. The printing mechanism includes a printing pad and a second driving source, and the second driving source is capable of driving the printing pad to perform a horizontal movement to move horizontally or to perform a vertical movement to move vertically.

The printing plate mechanism includes a printing plate and a base, and the printing plate is connected to a top member of the base.

The pad printer is characterized in that the base includes a carrying section and a heating section provided in the carrying section. The heat section generates an amount of heat for heating the printing plate, such that the printing plate in contact with the ink cup assembly is maintained at a set temperature and ink in the ink cup assembly in contact with the printing plate is also maintained at the set temperature in the process of pad printing.

The carrying section includes a supporting seat and the heating section includes a heating element and a temperature sensor. The supporting seat is formed with a first receiving recess for receiving the heating element therein and a second receiving recess for receiving the temperature sensor therein. And, the temperature sensor is located in the vicinity of the heating element.

The top member includes a first connecting section for holding the supporting seat and a second connecting section for connecting the printing plate. In an embodiment, the heating element is a silicone heating pad for maintaining the base and the ink cup assembly at the set temperature.

The first receiving recess includes a first wiring zone communicating with an outer edge of the supporting seat and a first closed zone communicating with the first wiring zone. The second receiving recess includes a second wiring zone communicating with an outer edge of the supporting seat and a second closed zone communicating with the second wiring zone.

The pad printer further includes a machine body, which includes a human-machine interface and a communication device. The human-machine interface is electrically connected to the first driving source, the second driving source and the heating section, so that a user may complete ink temperature setting and overall pad printing setting directly at the human-machine interface. And, the communication device can be connected to an external electronic device, so that the pad printer can be remotely operated and controlled at the external electronic device.

The present invention is characterized in that the printing plate mechanism includes a heating section, which generates heat for heating the printing plate, so that the printing plate in contact with the ink cup assembly is maintained at a set temperature and ink in the ink cup assembly in contact with the heated printing plate is also maintained at the set temperature in the process of pad printing. Therefore, even if the pad printer performs pad printing in different ambient temperatures, its ink can always be maintained at the same set temperature through several heating steps to ensure stable pad printing quality.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a thermostatic color ink cup pad printer according to a preferred embodiment of the present invention;

FIG. 2 is a partially enlarged side view of FIG. 1;

FIG. 3 is a partially enlarged perspective view of FIG. 2;

FIG. 4 is an exploded perspective view of an ink cup mechanism of the thermostatic color ink cup pad printer of FIG. 1;

FIG. 5 is an exploded view of an ink cup assembly of the ink cup mechanism of FIG. 4;

FIG. 6 is an exploded perspective view of a printing mechanism of the thermostatic color ink cup pad printer of FIG. 1;

FIG. 7 is an exploded perspective view of a printing plate mechanism of the thermostatic color ink cup pad printer of FIG. 1;

FIG. 8A shows that an amount of ink is supplied to the printing plate when the thermostatic color ink cup pad printer of FIG. 1 operates;

FIG. 8B shows that a printing pad of the printing mechanism uptakes the ink from the printing plate when the thermostatic color ink cup pad printer of FIG. 1 operates; and

FIG. 8C shows that the ink is pad transferred onto an item to be printed when the thermostatic color ink cup pad printer of FIG. 1 operates.

### DETAILED DESCRIPTION OF THE PREFERRED EMBODIMENTS

The present invention will now be described with a preferred embodiment thereof and by referring to the accompanying drawings.

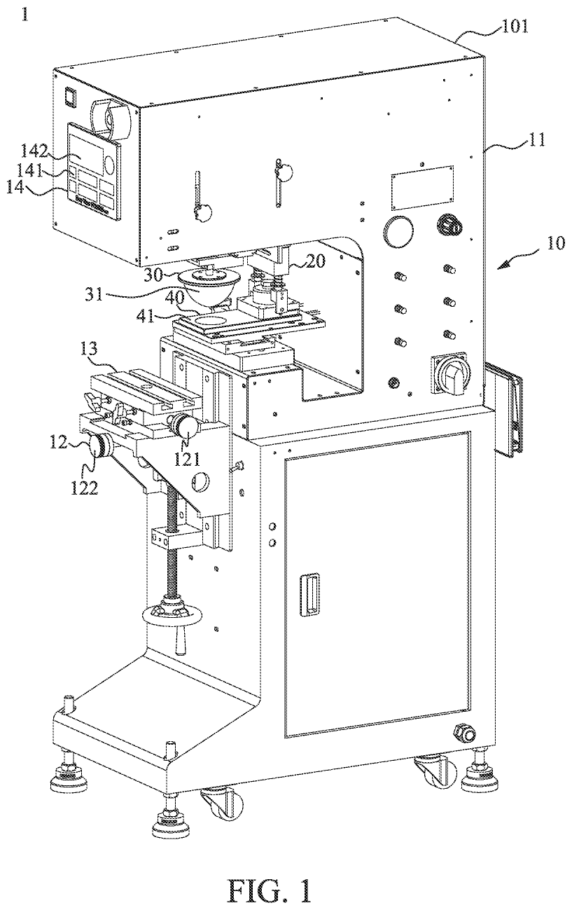

Please refer to FIG. 1. A thermostatic color ink cup pad printer 1 according to a preferred embodiment of the present invention, which is also briefly referred to the pad printer 1 herein, includes a machine body 10, an ink cup mechanism 20, a printing mechanism 30 and a printing plate mechanism 40. The machine body 10 includes a plurality of panels 11, a plurality of fastening elements 12, a processing platform 13, a human-machine interface 14, and a communication device (not shown). The fastening elements 12 are mounted to a lower side of the processing platform 13 and include a first fastening element 121 for moving the processing platform 13 horizontally and a second fastening element 122 for moving the processing platform 13 vertically. The human-machine interface 14 is located at a top portion 101 of the machine body 10.

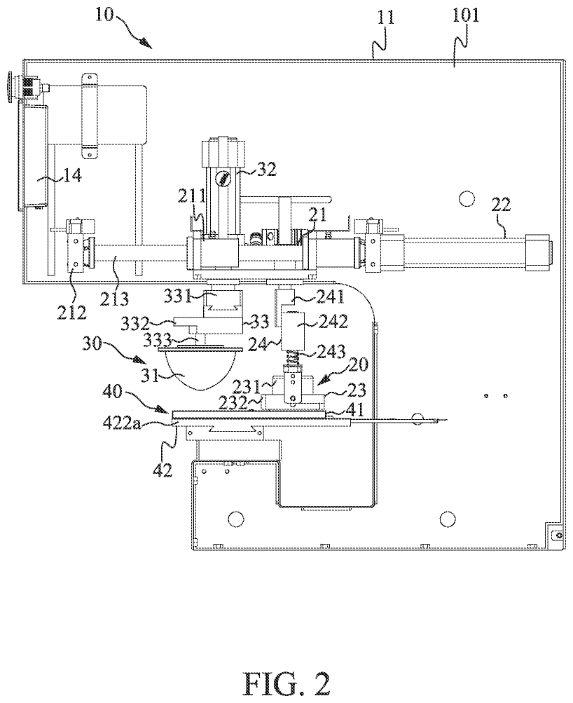

Please refer to FIGS. 1, 2 and 3. The ink cup mechanism 20 includes a sliding table assembly 21, a first driving source 22, an ink cup assembly 23, and a first air cylinder assembly 24. The sliding table assembly 21 includes a sliding seat 211, a plurality of fixed seats 212 located at two opposite ends of the sliding seat 211, and a plurality of guide rods 213 located at two opposite sides of the sliding seat 211 and respectively having a diametrical size smaller than a bore size provided on the sliding seat 211. The guide rods 213 are set in the sliding seat 211 and connected at respective one end to the one of the two fixed seats 212, such that the sliding seat 211 is movable on along the guide rods 213 in reciprocal motion horizontally. The other fixed seat 212 is fixedly located between the sliding seat 211 and the first driving source 22.

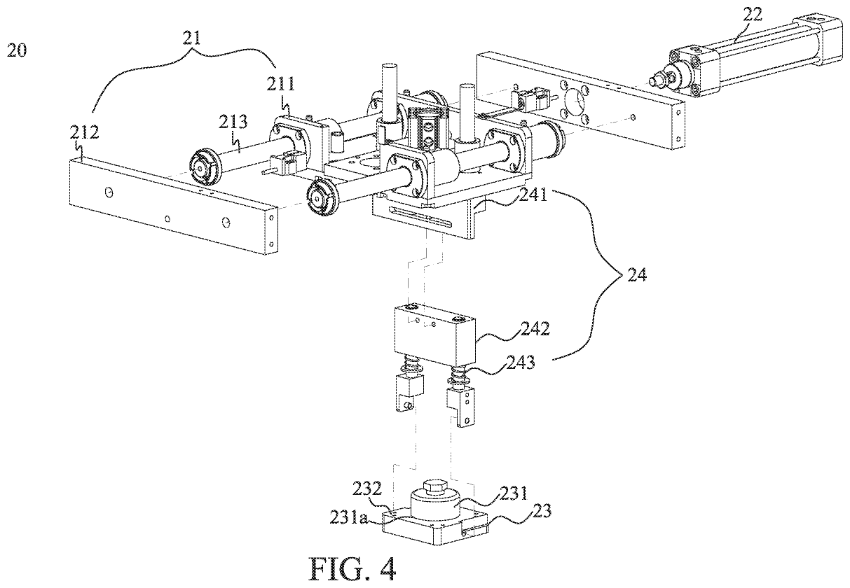

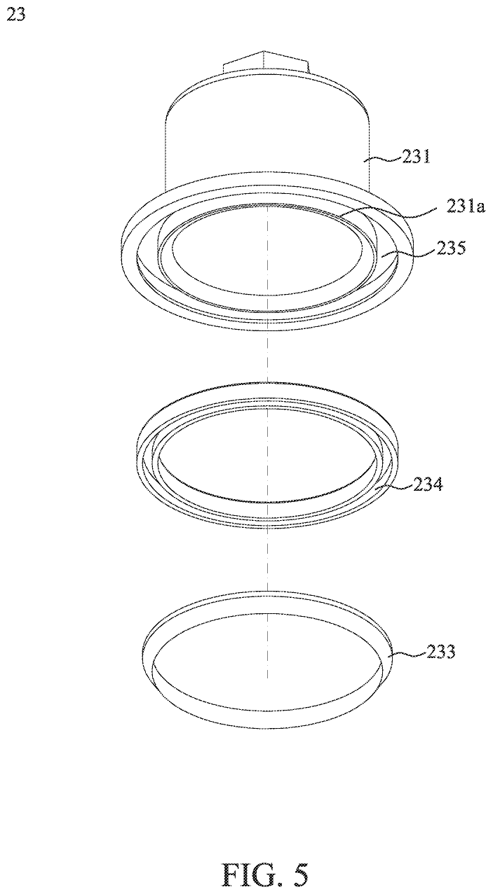

Please refer to FIGS. 4 and 5. The ink cup assembly 23 includes an ink cup 231, an ink cup hood 232, a blade ring 233, and a rubber ring 234. The blade ring 233 and the rubber ring 234 are circumferentially located between a lower section 231a of the ink cup 231 and the ink cup hood 232. Further, the rubber ring 234 is retained in an engaging space 235 defined by between the lower section 231a of the ink cup 231 and the blade ring 233. The rubber ring 234 has a diameter larger than that of the blade ring 233 but smaller than that of the lower section 231a of the ink cup 231. The first air cylinder assembly 24 includes a first air cylinder 241, a first lift mount 242, and a plurality of first links 243. The first lift mount 242 connects the first air cylinder 241 to the first links 243 for locking the ink cup assembly 23 in place; and the first links 243 connect the first lift mount 242 to the ink cup hood 232.

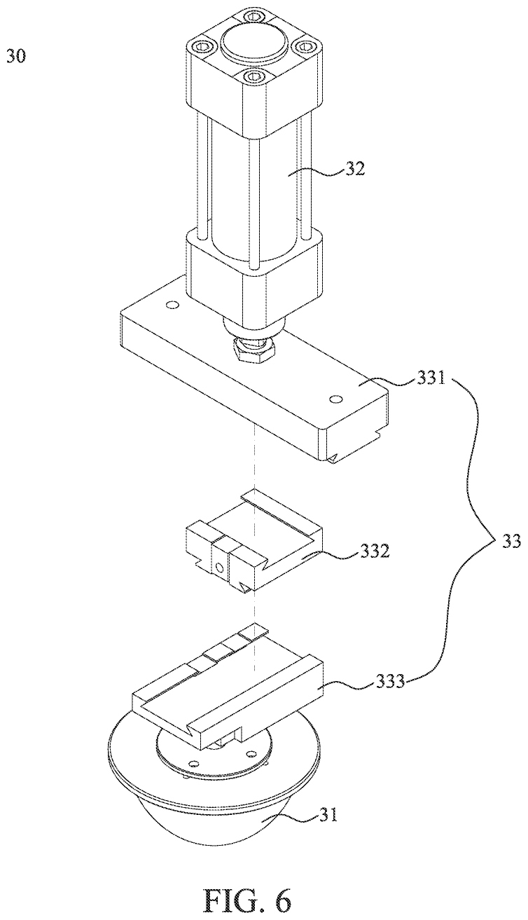

Please refer to FIG. 6. The printing mechanism 30 includes a printing pad 31, a second driving source 32, and a second air cylinder assembly 33. The second air cylinder assembly 33 includes a second air cylinder 331, a second lift mount 332, and a second link 333. The second lift mount 332 connects the second air cylinder 331 to the second line 333 for locking the printing pad 31 in place; and the second link 333 connects the second lift mount 332 to the printing pad 31.

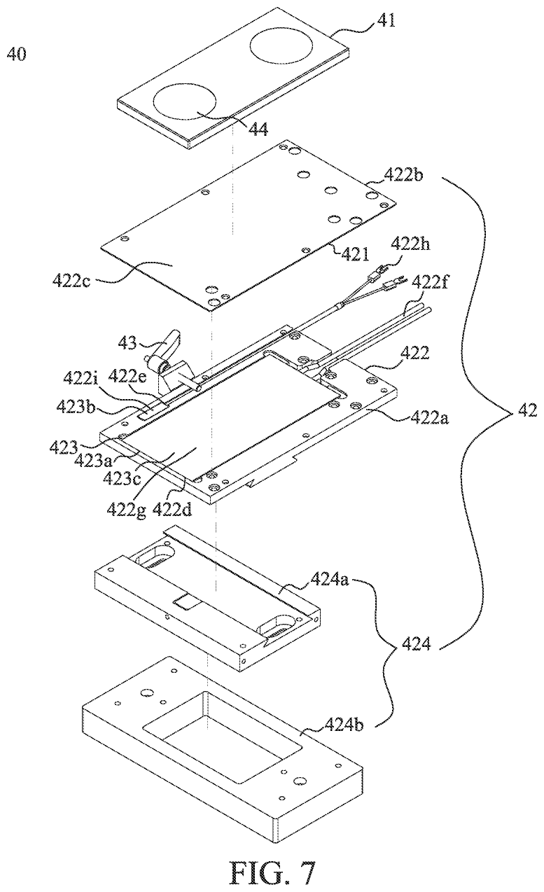

Please refer to FIG. 7. The printing plate mechanism 40 includes a printing plate 41, a base 42, and a tightening element 43. The printing plate 41 is located between the ink cup mechanism 20 and the base 42. More specifically, the printing plate 41 is located between the ink cup assembly 23 and a top member 421 of the base 42. The base 42 further includes a carrying section 422, a heating section 423, and a fixing section 424. The carrying section 422 includes a supporting seat 422a, which is covered by the top member 421 of the base 42; a first connecting section 422b located on the top member 421 for holding the supporting seat 422a in place; and a second connecting section 422c, which is different from the first connecting section 422b, for holding the printing plate 41 in place. The fixing section 424 includes a first fixing member 424a located adjacent to the supporting seat 422a and a second fixing member 424b fixedly set to one side of the first fixing member 424a.

As can be seen in FIG. 7, the heating section 423 is provided in the carrying section 422 and includes a heating element 423a and a temperature sensor 423b located in the vicinity of the heating element 423a. The heating element 423a is capable of generating an amount of heat (not shown), and the temperature sensor 423b is capable of detecting a temperature of the base 42. In the illustrated embodiment, the heating element 423a is a silicone heating pad 423c.

As shown in FIG. 7, the supporting seat 422a includes a first receiving recess 422d for receiving the heating element 423a therein and a second receiving recess 422e for receiving the temperature sensor 423b therein. The first receiving recess 422d has an area larger than that of the second receiving recess 422e. Further, the first receiving recess 422d includes a first wiring zone 422f communicating with an outer edge of the supporting seat 422a and a first closed zone 422g communicating with the first wiring zone 422f; and the second receiving recess 422e includes a second wiring zone 422h communicating with an outer edge of the supporting seat 422a and a second closed zone 422i communicating with the second wiring zone 422h. Both of the first and the second wiring zone 422f, 422h are located below the printing plate 41. And, both of the first closed zone 422g and the second closed zone 422i are fixedly located between the top member 421 and the supporting seat 422a.

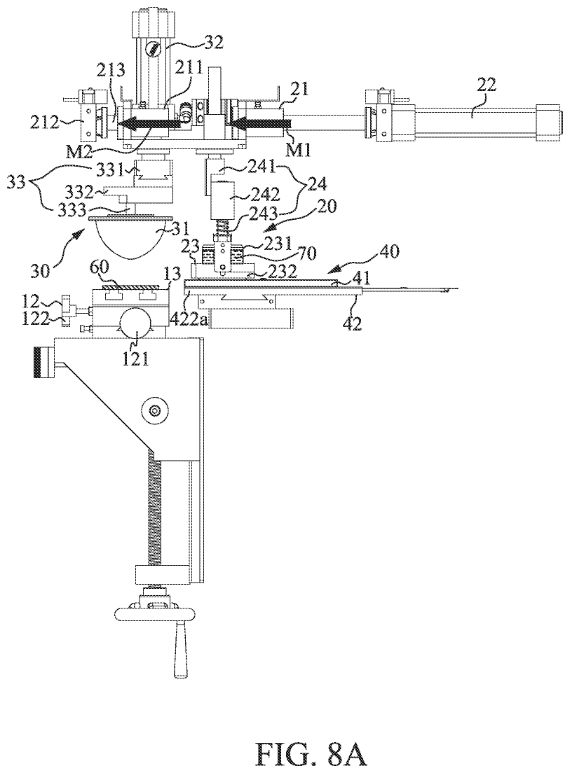

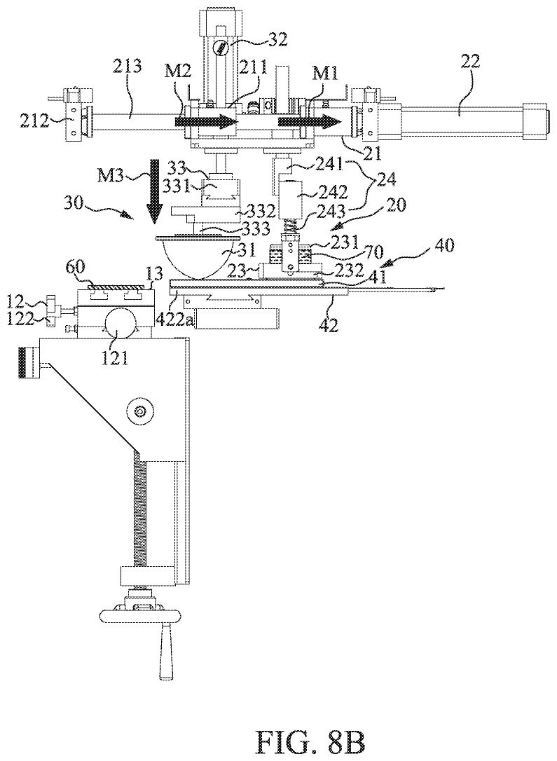

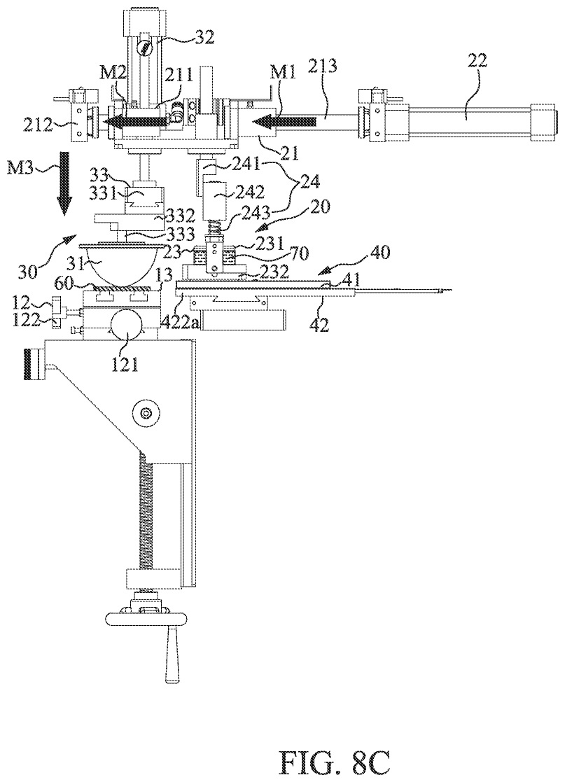

Please refer to FIG. 8A. When the pad printer 1 according to the illustrated embodiment operates, the first driving source 22 drives the ink cup assembly 23 to perform a first movement M1 for the ink cup assembly 23 to move horizontally to a position farther away from the machine body 10 and closer to an item 60 that is to be printed, and the second driving source 32 simultaneously drives the printing pad 31 to perform a parallel movement M2 for the printing pad 31 to move horizontally to a position farther away from the machine body 10 and closer to the item 60 to be printed, so that the ink cup assembly 23 can touch the printing plate 41. Heat (not shown) generated by the heating section 423 (see FIG. 7) is transferred via the top member 421 of the base 42, which is connected to the printing plate 41, to the printing plate 41, so that the printing plate 41 is maintained at a set temperature (not shown). Meanwhile, ink 70 stored in the ink cup assembly 23 in contact with the heated printing plate 41 is also heated to maintain at the set temperature (not shown). The ink 70 in the ink cup assembly 23 is then supplied into a pattern 44 (see FIG. 7) that is recessed from an upper surface of the printing plate 41, such that the ink 70 fills up the recessed pattern 44. It is noted one or a plurality of patterns 44 can be formed on the printing plate 41 without being particularly limit in number (see FIG. 7).

Please refer to FIGS. 5 and 8B at the same time. Then, the first driving source 22 drives the ink cup assembly 23 to perform the first movement M1 for the ink cup assembly 23 to move horizontally to a position farther away from the item 60 to be printed and closer to the machine body 10, so that the blade ring 233 in the ink cup 231 scrapes off excessive ink 70 that is applied on the printing plate 41 but not filled in the recessed pattern 44. Meanwhile, the second driving source 32 drives the printing pad 31 to perform the parallel movement M2 for the printing pad 31 to move horizontally to a position farther away from the item 60 to be printed and closer to the machine body 10. Then, the second driving source 32 drives the printing pad 31 to perform a vertical movement M3 for the printing pad 31 to move vertically toward the printing plate 41, so that the printing pad 31 is in contact with the printing plate 41 to uptake the ink 70 that is left on the printing plate 41.

Please refer to FIG. 8C. The second driving source 32 then drives the printing pad 31 to perform the vertical movement M3 for the printing pad 31 to move vertically to a position farther away from the printing plate 41. On the other hand, the first driving source 22 drives the ink cup assembly 23 to perform the first movement M1 for the ink cup assembly 23 to move horizontally to a position farther away from the machine body 10 and closer to the item 60 to be printed. Meanwhile, the second driving source 32 drives the printing pad 31 to perform the parallel movement M2 for the printing pad 31 to move horizontally to a position farther away from the machine body 10 and closer to the item 60 to be printed. Then, the second driving source 32 drives the printing pad 31 to perform the vertical movement M3 for the printing pad 31 to move toward the item 60 to be printed until the printing pad 31 is in contact with the item 60 to be printed to transfer the ink 70 onto the item 60.

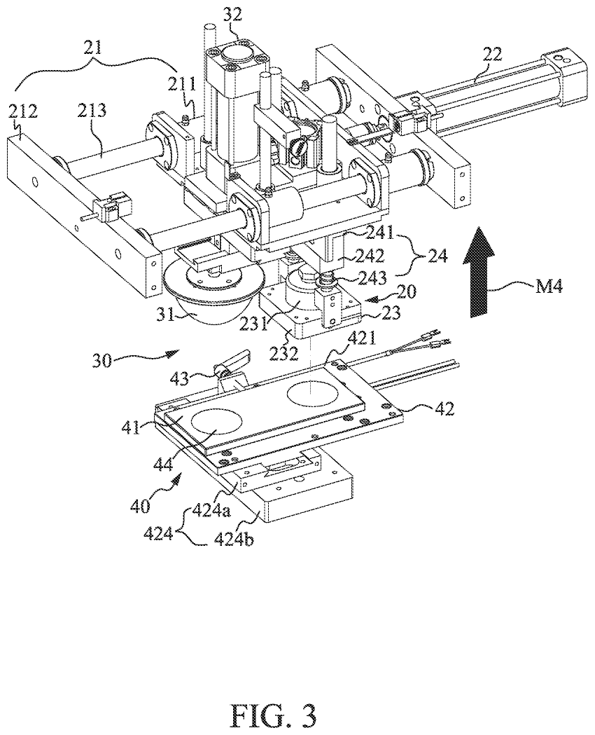

Please refer to FIGS. 3 and 7 at the same time. To print a different pattern 44 onto the item 60 to be printed, it is necessary to change the printing plate 41 to another one. To remove the printing plate 41 from the pad printer 1, first use the first driving source 22 to drive the ink cup assembly 23 to perform a second movement M4 for the ink cup assembly 23 to move vertically away from the printing plate 41. Then, turn the tightening element 43 to loosen the printing plate 41 from the top 421 of the base 42. Thereafter, move the printing plate 41 horizontally toward the item 60 to be printed and away from the machine body 10. Then, the printing plate 41 can be easily removed from the pad printer 1 and replaced with another printing plate 41 having a different pattern 44 formed thereon.

Please refer to FIGS. 1, 2 and 7. The human-machine interface 14 includes a plurality of input keys 141 and a plurality of display fields 142, and can be electrically connected to the first driving source 22, the second driving source 32 and the heating section 423. The user may click directly on the human-machine interface 14 to enable the pad printer 1 to adjust temperature setting in the process of pad printing. In the event the pad printer 1 stops working due to any trouble in the process of pad printing and the display fields 142 turn to red warning lights, the user may click directly on the input keys 141 on the human-machine interface 14 to immediately stop all operations of the pad printer 1 without causing a power off. However, there is not particular limit to the way the user operates the pad printer 1. In addition to the direct clicking on the human-machine interface 14, the user may also connect the communication device (not shown) to an external electronic device (not shown) to operate the pad printer 1 through a remote connection as well as to monitor and control the pad printing quality from a remote location.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A thermostatic color ink cup pad printer, comprising:
an ink cup mechanism including an ink cup assembly and a first driving source, and the first driving source being capable of selectively driving the ink cup assembly to perform a first movement to move horizontally or to perform a second movement to move vertically;
a printing mechanism including a printing pad and a second driving source, and the second driving source being capable of driving the printing pad to perform a horizontal movement to move horizontally or to perform a vertical movement to move vertically; and
a printing plate mechanism including a printing plate and a base, and the printing plate being connected to a top member of the base; and
the pad printer being characterized in that the base further includes a carrying section and a heating section provided in the carrying section; the heat section generating an amount of heat for heating the printing plate, such that the printing plate in contact with the ink cup assembly is maintained at a set temperature and ink in the ink cup assembly in contact with the printing plate is also maintained at the set temperature in the process of pad printing; and
wherein the carrying section includes a supporting seat and the heating section includes a heating element and a temperature sensor; the supporting seat being formed with a first receiving recess for receiving the heating element therein and a second receiving recess for receiving the temperature sensor therein; and the temperature sensor being located in the vicinity of the heating element.

2. The thermostatic color ink cup pad printer as claimed in claim 1, wherein the top member includes a first connecting section for holding the supporting seat and a second connecting section for connecting the printing plate.

3. The thermostatic color ink cup pad printer as claimed in claim 1, wherein the heating element is a silicone heating pad for maintaining the base and the ink cup assembly at the set temperature.

4. The thermostatic color ink cup pad printer as claimed in claim 1, wherein the first receiving recess includes a first wiring zone communicating with an outer edge of the supporting seat and a first closed zone communicating with the first wiring zone.

5. The thermostatic color ink cup pad printer as claimed in claim 4, wherein the second receiving recess includes a second wiring zone communicating with an outer edge of the supporting seat and a second closed zone communicating with the second wiring zone.

6. The thermostatic color ink cup pad printer as claimed in claim 1, further comprising a machine body, the machine body includes a human-machine interface; the human-machine interface being electrically connected to the first driving source, the second driving source and the heating section, so that a user may complete ink temperature setting and overall pad printing setting directly at the human-machine interface.

7. The thermostatic color ink cup pad printer as claimed in claim 6, wherein the machine body includes a communication device; the communication device being connectable to an external electronic device, so that the pad printer can be remotely operated and controlled at the external electronic device.
